(19) United States
(12) Patent Application Publication
(10) Pub. No.: US 2008/0204666 A1
(43) Pub. Date: Aug. 28, 2008

(54) IMAGE PROJECTION AND CAPTURE SYSTEMS

(76) Inventor: Robert Spearman, Bremerton, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/025,494

(22) Filed: Feb. 4, 2008

Related U.S. Application Data
(60) Provisional application No. 60/887,995, filed on Feb. 2, 2007.

(51) Int. Cl. G03B 21/28

(52) U.S. Cl. 353/37; 353/98; 353/69

(57) ABSTRACT

An image projection system is provided that includes a projector configured to generate a visible projected image, a screen having an interior surface enclosing a three-dimensional space, and a reflector configured to receive the visible projected image from the projector and to reflect the visible image on the interior surface of the screen, the reflector having an aspherical reflective surface that adapts the visible image from the projector for display on the interior surface of the screen, ideally without distortion and without using software warping, to provide complete coverage of the interior surface of the screen.

### BACKGROUND OF THE INVENTION

1. Field of the Invention

The present disclosure is directed to optical projection and capture systems and methods and, more particularly, to dome projection and capture mirrors for polar projection content.

2. Description of the Related Art

Many image projection systems typically use a projector that transmits a visible image via light waves onto a viewing screen. While flat viewing screens are typically used, images can be projected onto dome-shaped screens, such as in a planetarium.

Digital projection onto a dome has most commonly been accomplished with a single projector having a fisheye lens located at the center of the dome or with an array of edge-blended projectors positioned in or around the dome. These projection systems are typically used in planetariums, immersive digital theaters, or virtual reality simulators.

In recent years, a spherical mirror projection method has been developed at Swinburne University in Australia under the trade name “MirrorDome.” This system utilizes a portion of a spherical mirror, a data projector aimed at the mirror, and a computer running specialized software. In order to counteract severe distortion in the mirror, each video frame must be “warped” by the software before it is sent to the projector. The images are projected onto a dome after reflecting off the mirror.

FIG. 1 is an example 180 degree field of view polar projection of the night sky produced by typical planetarium software. As can be seen therein, constellation line drawings 12, cardinal points, and the date and time are also displayed.

FIG. 2 is an example of how a similar polar projection would be warped for spherical mirror projection. An azimuthal grid is superimposed on the sky to better illustrate the significant distortion.

In use, the spherical mirror projection system is placed at the edge of the dome. A spherical mirror as used in such a system is typically manufactured by applying a first surface mirror finish to a spherical plastic shape. Typically only one quarter of a sphere is used in a system.

Due to the mirror geometry, such a system can project more pixels than a full dome fisheye lens (a lens with full coverage of a dome screen) using the same resolution projector. This system can use lower cost projectors that typically are not well suited for a fisheye lens. The projector can potentially be upgraded without requiring a new mirror, and this mirror is less costly to produce than a lens.

However, there are some substantial drawbacks to a spherical mirror dome projection system. For example, the system as typically configured does not cover the entire dome. In a planetarium setting, this means parts of the horizon and sky are blank or obscured by the mirror, which obviously makes an astronomy educator's job more difficult and erodes the immersive experience for the audience. While full dome coverage is possible, it produces lower resolution projection in some areas of the dome than would be produced by a full dome fisheye lens on a projector of the same resolution.

Because the projection is not evenly distributed, pixels vary widely in size across the dome and the black level is not constant. In addition, a data projector is not designed to focus on a curved surface, so some areas of the projection can be out of focus, depending on the depth of focus of the projector. These issues are particularly troublesome for planetarium projection, where stars should be well defined and not vary in size as they pass across the dome. An inconsistent black level in a star field simulation can be quite noticeable, especially if it interferes with a Milky Way simulation.

This system also requires the use of software warping and brightness adjustment algorithms in the display software applications in order to correct for the mirror distortion, which adds cost and complexity. The warping algorithms are generally designed to take the common 180 degree polar projection format application output and warp this output based on the system geometry for projection onto the mirror. Unfortunately, this warping affects the image quality. As the original source frames are warped, some detail must be compressed, and other areas may be expanded, resulting in reduced image quality. This is a particular problem for planetariums because of the inherent fine detail and high contrast in a starfield simulation. Pinpoint stars on a perfectly black field is the ideal of many planetarium purchasers.

FIGS. 3 and 4 illustrate the difficulty with a spherical mirror dome projection system. These two figures show respective images of the constellation Grus. FIG. 3 is a fragment of a standard polar projection view using Stellarium planetarium software, XGA resolution, and 180° full screen view. The image of FIG. 4 is with the same configuration but using the standard Stellarium spherical mirror warping feature configured for an XGA resolution projector. The Grus constellation outline has an angular size of approximately 19° in the sky.

As can be seen in a comparison of FIGS. 3 and 4, the constellation lines have several odd warping artifacts. But worse, stars are blurred and dimmer stars are now almost invisible. Note that these are screen shots from the video frame before it is projected onto the dome.

### BRIEF SUMMARY OF THE INVENTION

The embodiments of the present disclosure are directed to dome projection mirrors for polar projection content.

In accordance with one embodiment, an image projection system is provided that includes a projector configured to generate a visible projected image, a screen having an interior surface enclosing a three-dimensional space, and a reflector configured to receive the visible projected image from the projector and to reflect the visible image on the interior surface of the screen, the reflector having an aspherical reflective surface that adapts the visible image from the projector for display on the interior surface of the screen, ideally without distortion and without using software warping, to provide complete coverage of the interior surface of the screen.

In accordance with another aspect of the foregoing embodiment, the reflector is configured to provide uniform coverage of the screen by the displayed image.

In accordance with another aspect of the foregoing embodiment, the reflector is configured to provide non-uniform coverage of the screen by the displayed image for more efficient utilization of the full image frame of the projector.

In accordance with another aspect of the disclosed embodiment, the projector includes one from among a data projector, a film projector, a slide projector, and a laser projector. Ideally the projector uses a polar projection image source.

In accordance with another aspect of the foregoing embodiment, the screen has a truncated spherical shape, such as a hemispherical shape, and the reflecting surface has either a concave, convex, or saddle configuration.

In accordance with another aspect of the foregoing embodiment, one or more mirrors are provided that are configured to reflect the visible image from the projector onto the reflector, thus providing a folded reflection to enhance compactness of the system.

In accordance with another aspect of the foregoing embodiment, a converter is provided that is configured to receive the projected image from the projector and to reduce the projected image prior to reception by the reflector.

In accordance with another aspect of the foregoing embodiment, the projector includes a plurality of image projection devices and the reflector includes a plurality of aspherical reflective devices, each projection and reflective device cooperating to produce a substantially equal portion of the projected image for display on the screen to obtain enhanced image brightness and resolution.

In accordance with another embodiment, an aspherical mirror reflects the surface of a three dimensional concave screen for capture by a camera.

In accordance with a method of the present disclosure, an aspherical reflective surface is generated by obtaining data regarding a projection dome radius, a three-dimensional center of a mirror in the dome, a three-dimensional location of a projection point of a visible image in the dome, an angular height of the projected visible image, and a desired image to dome location mapping. The surface normal at a center point is determined whereby a central ray projected from the projector is reflected up to the zenith of the dome. Working out from the center to the edge of the source image, the intersection of a projection vector with the surface of the mirror as defined by a plane defined by the last normal vector at a previous point is determined. The normal vector of the surface at this new point is determined from the desired mapping of the location of the visible image on the screen for this location in the source image. This is repeated until the edge of the source image is reached, and another ray is followed out from the center of the source image. With sufficient rays and points along each ray determined, the mirror surface is defined.

### BRIEF DESCRIPTION OF THE SEVERAL VIEWS OF THE DRAWING(S)

The foregoing and other features and advantages of the present disclosure will be more readily appreciated as the same become better understood from the following detailed description when taken in conjunction with the accompanying drawings, wherein:

FIG. 1 is an example of a polar projection simulation of the night sky;

FIG. 2 is an example of warping required for existing spherical mirror projection systems;

FIGS. 3 and 4 are comparison images of the constellation Grus generated without and with mirror warping software features, respectively;

FIG. 5 is an illustrative diagram of a projection system formed in accordance with one embodiment of the present disclosure;

FIG. 6 is an illustrative diagram of another embodiment of the projection system formed in accordance with the present disclosure;

FIG. 7 is a diagram illustrating use of a conversion lens formed in accordance with the present disclosure;

FIG. 8 is an illustration of another embodiment of the present disclosure in which a reflector designed for a horizontal dome is used in a vertically oriented dome;

FIG. 9 is another embodiment illustrating a reflector designed for a vertical dome;

FIG. 10 is a diagram illustrating placement of multiple projectors and reflectors in a dome projection system;

FIG. 11 is a diagram illustrating another configuration of multiple projectors and reflectors in conjunction with a dome projection system;

FIG. 12 is a plot of mirror surface depth along rays radiating from the center of a projected image out to the edge of a concave mirror formed in accordance with the present disclosure; and

FIG. 13 is a plot of mirror surface depth along rays radiating from the center of a projected image out to the edge in a convex mirror designed in accordance with the present disclosure.

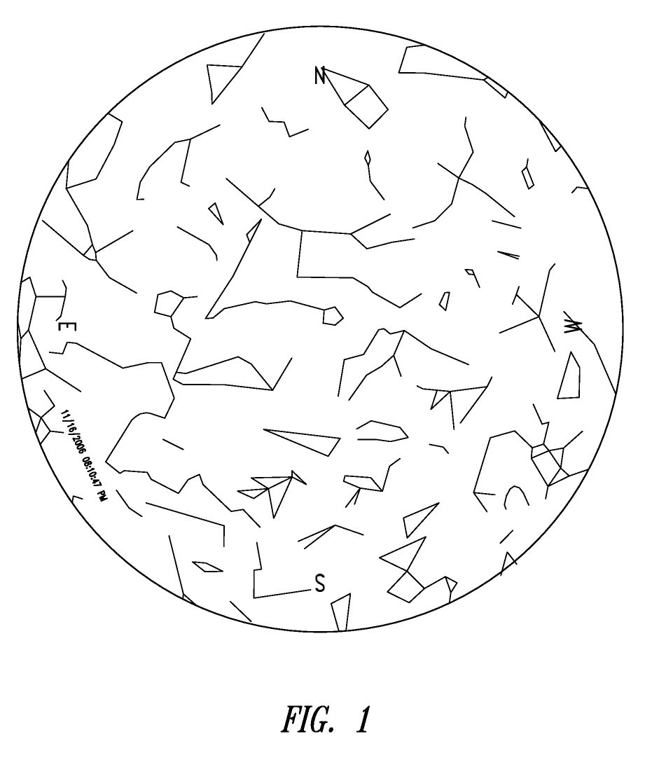

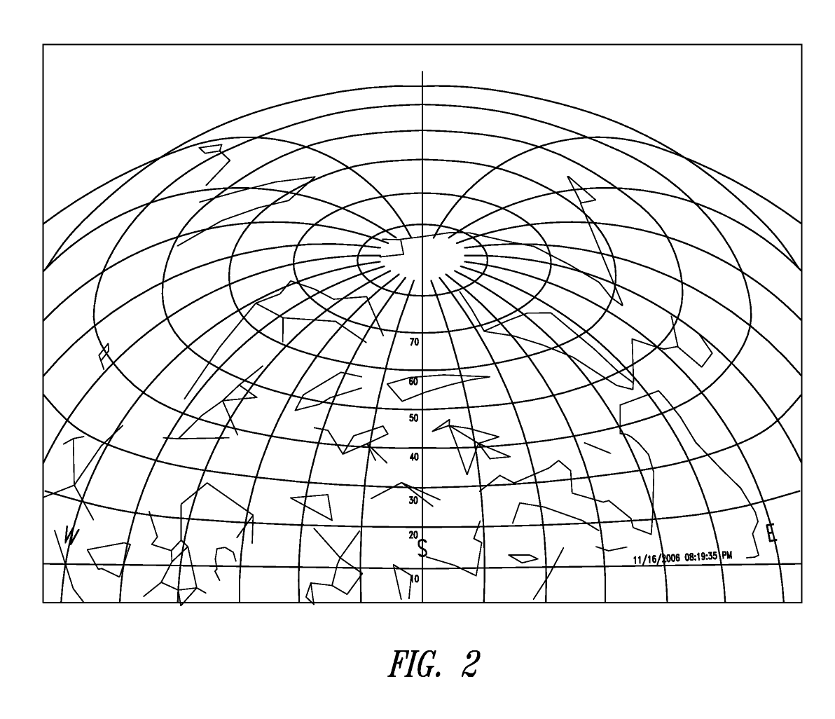

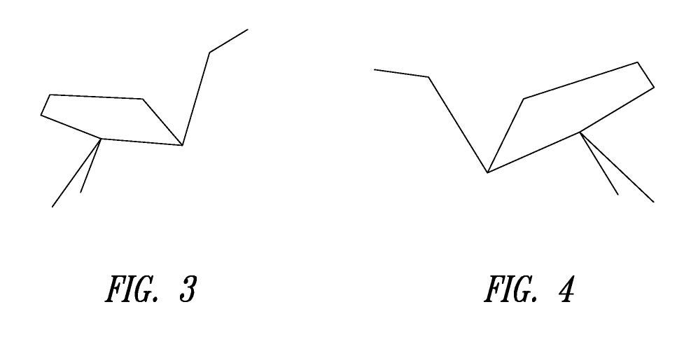

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with projection systems, including but not limited to power supplies, controllers, and related software have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### Basic Concept

In the embodiments disclosed herein, an aspherical mirror is designed in such a way that a polar projection formatted image can be projected onto the mirror and then onto a truncated spherical screen without generally requiring any software warping and allowing complete coverage of the screen surface. When projected onto the screen without distortion, all angular dimensions of the projected image, as measured from an appropriate central viewpoint, match those defined in the source polar projection.

A standard linear polar projection (sometimes called a dome master or fisheye image) is the standard format for full dome video frames or other content used as source material for a dome projection system. The field of view is typically 180 degrees to provide a full sky view down to the simulated horizon. As with other dome projection systems, larger or smaller fields of view can be projected with an aspherical mirror.

Due to the unique mirror, as the size of the projected image is reduced, the projected image moves further up the dome while keeping relative proportions the same in the displayed image. This offers additional flexibility inherent in one mirror to support different dome coverage and different projectors with different projection angular sizes. In one embodiment, the mirror is designed to allow a horizon lower than the mirror; however, the user can choose to have a full horizon projection (with no obstruction by the mirror) higher up the dome by simply adjusting the source image size or the zoom on the projector. The source image field of view would also need to be adjusted to the selected dome coverage to remove distortion.

These mirrors can be used with any type of image forming projection device, including data projectors, film or slide projectors, or laser projectors.

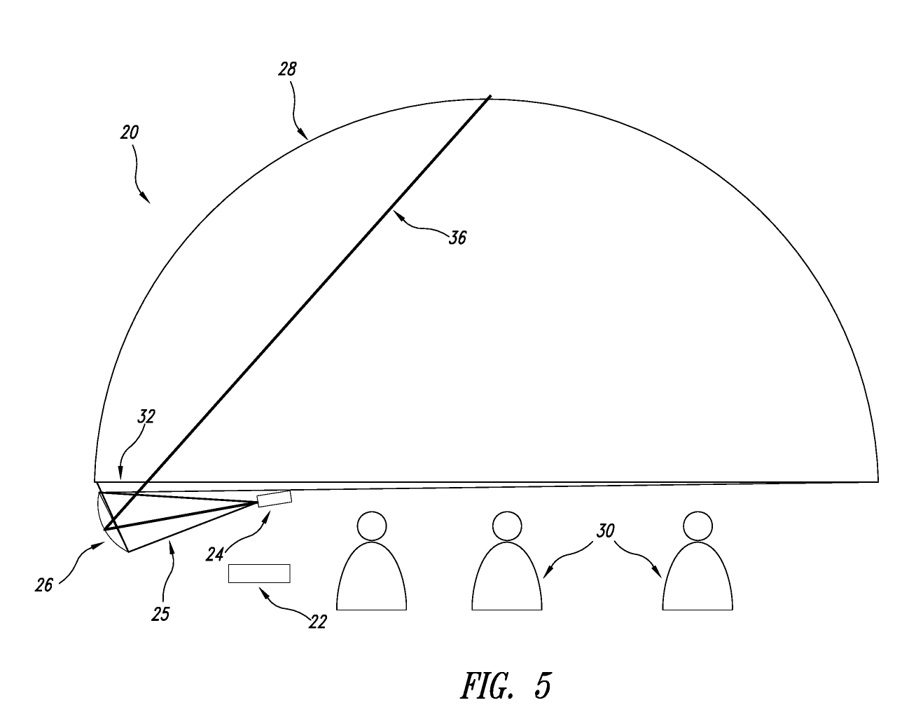

In one embodiment shown in FIG. 5, the system 20 consists of a polar projection video source, such as a computer 22 running planetarium software or playing full dome video content. The video frames are projected through a digital projector 24 as a projected image 25 onto a concave aspherical mirror 26. The mirror 26 reflects the projected image 25 onto the hemispherical projection surface 28 with minimal interference with the audience members 30. For the most effective immersive experience, the audience 30 can sit just below the projected horizon 32 without blocking the projection. This is particularly important for portable dome environments due to space constraints.

The main drawback with this system is that typical data projectors do not focus very close to the projector (typically 3-5 feet minimum focus distance), and the projector needs to focus somewhat in front of the concave mirror in order to focus well on the dome. This ends up requiring a relatively large mirror. This increases the distortion that becomes apparent if the system is used in larger or smaller domes than intended. The smaller the mirror, the less distortion between different dome sizes. Even a mirror designed for the center of the dome will produce distortion over different dome sizes unless it is very small. Generally the edge of the dome is the best location for a mirror as this places the shortest depth of focus requirement on the projector.

The system can be tilted and shifted to reduce dome size related distortion. In some applications, such as playing movies or video games, the distortion may be unimportant and not need to be corrected. In the worst case scenario, software distortion correction can be implemented. Because the distortion is much less than with any spherical mirror system, warping artifacts are less noticeable if warping is used. However, it is likely that in most cases the distortion correction could be done (in planetarium simulation software, for example) without resorting to the whole screen warping method, but simply implemented as another projection type in the software. This produces a higher quality starfield than if warping is used. If the projector vertical image offset is substantially different from the one for which the mirror was designed, simple software distortion (scaling along the vertical image dimension) can be used to correct this problem.

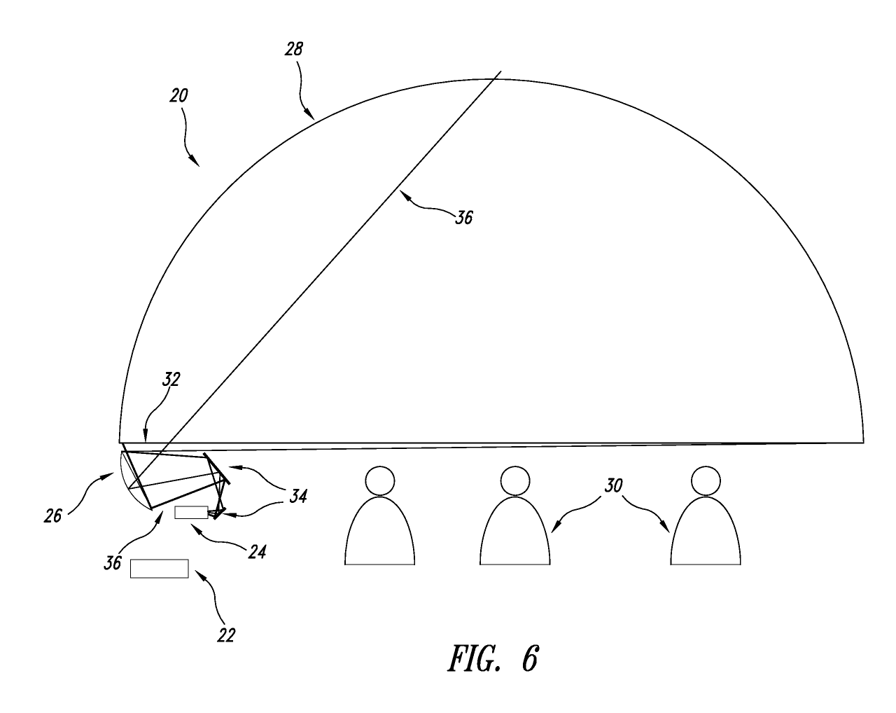

To reduce the amount of space the system 20 takes up in the dome 28, one or more flat mirrors 34 can be used to fold the projection beam 36, as shown in FIG. 6. Thus the projector 24 could be located under the aspherical mirror 26 to leave more room for the audience.

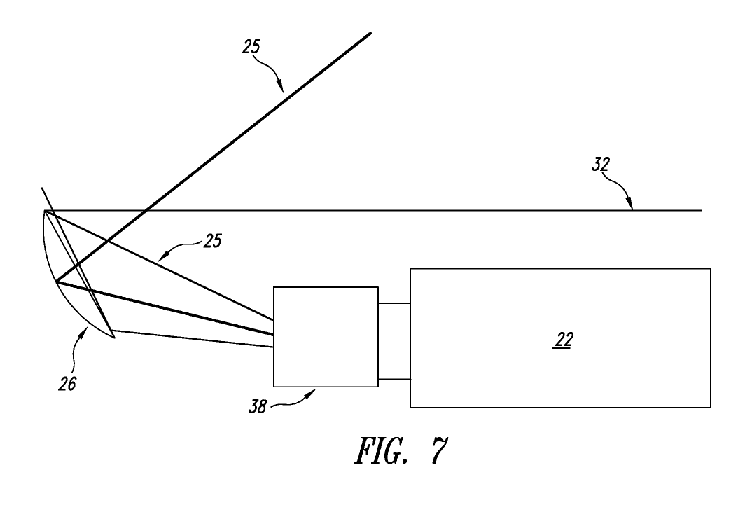

To reduce mirror size and dome size related distortion, a conversion lens 38 can be used in conjunction with the projector, as shown in FIG. 7. An off-the-shelf telephoto converter 40 can shrink the image size at the minimum focus distance, allowing a smaller mirror, or a conversion lens could be used to reduce the image size and the focus distance for a more compact system. The converter 40 can be designed to focus in an optimal way for the best focus over the dome.

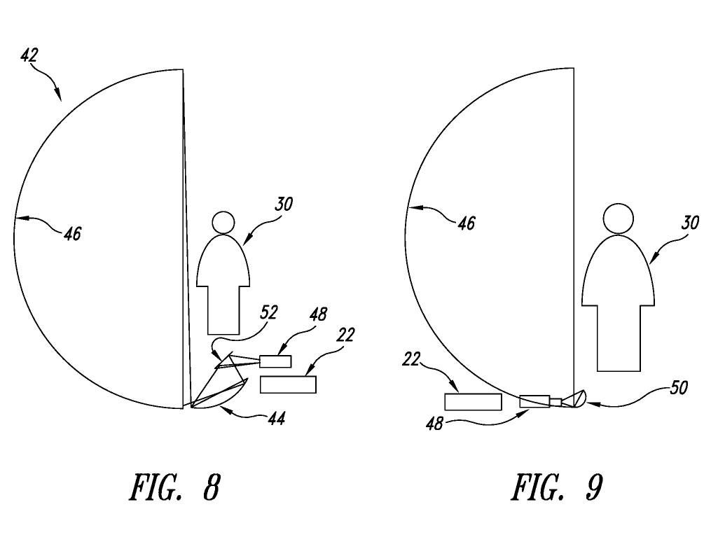

FIG. 8 is a diagram of a system 42 illustrating using a polar distortion aspheric mirror 44 with a vertically oriented dome 46. The most compact arrangement is with the projector 48 projecting through a hole in the dome surface towards a mirror 50 designed for this arrangement, which is shown in FIG. 9. Otherwise a flat mirror 52 is required, as shown on the left in FIG. 8. Obviously the arrangement of FIG. 9 would easily allow projection over a translucent sphere using two projectors and mirrors. A single mirror projecting over an almost complete sphere would have a relatively large depth of focus requirement, which would require a conversion lens.

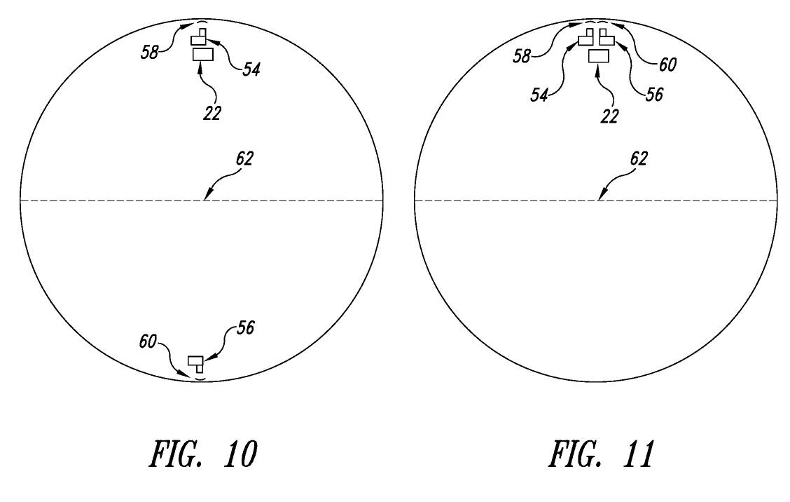

It is possible to use multiple projectors and mirrors for a brighter and higher resolution projection, such as a shown in FIG. 10. The source image frames are split into two halves vertically, and these are projected from two separate projectors 54, 56 using two aspheric mirrors 58, 60. The projection seam 62 is along a meridian through the zenith, so alignment is relatively easy. The seam 62 could be edge blended as needed to hide the seam. To reduce setup time, the two projectors 54, 56 could be mounted next to each other as shown in FIG. 11 (at the expense of some added distortion if the mirror 54, 56 is not specifically designed to be placed slightly off axis in the dome). An arrangement with 4 projectors is also quite straightforward.

A further application is to use a camera and aspherical mirror to capture moving or still images of a surface enclosing a three dimensional space. With a truncated spherical surface the output would ideally be a simple polar projection format without the expense of a fisheye lens. Images could be acquired for use with automated projector alignment systems or interactive control systems that react to images formed with detectable wavelengths superimposed on the projected content by the operator, such as from a laser pointer. In such an application, a filter in front of the camera to reduce or eliminate other wavelengths would simplify image processing. Captured video could also be recorded for future playback or relayed for remote viewing.

### Design Details

One method to design an aspherical mirror is to use a special purpose software design program to output a mirror design based on the following parameters:

dome radius;

3d location of the center of the mirror in the dome;

3d location of the projection point in the dome (determined based on projector vertical image offset, minimum focus distance, and projector tilt);

desired source image to screen location mapping; and

angular height of the projected image (based on projector design and zoom level).

The software works along rays from the center of the polar projection source image out to the edge. The position of the mirror center is defined, the projector location is defined, and the dome radius is defined. Therefore the surface normal at the center point can be determined so that a central ray of light from the projector is reflected up to the zenith of the dome.

The software works outward along each source image ray in steps. At each step it finds the intersection of a projection vector for that point in the source image with the mirror surface, approximated by a plane defined by the last normal vector at the last point on the mirror surface. The final location on the dome is known from the defined mapping, and thus the surface normal at this point on the mirror can be determined to produce the required reflection. Thus the entire surface can be defined in three dimensions given small enough steps.

The three dimensional point cloud generated from this simplistic ray tracing can then be approximated by a mathematical equation and imported into optical design software, as is understood by those familiar with the art. The system performance can be evaluated and the mirror surface equation adjusted as required.

In one embodiment, four basic mirror designs can be implemented: convex, concave, and two saddle shapes. The source polar projection has to be flipped vertically or horizontally or both for some of these concepts, and this can be accomplished with software or the projector itself and does not degrade the image quality.

The convex design is straightforward, but since the far horizon is reflected from towards the bottom of the mirror, it requires more clearance above the audience for a full horizon projection. In most portable planetariums, where the audience is seated just below the projected horizon, this is problematic, requiring a relatively high and less immersive projection height.

The concave design allows for more audience clearance, since the far horizon is almost horizontally projected for a full horizon projection just above the mirror. However, more care has to be taken with the design to prevent double reflections when the mirror protrudes above the horizon.

Any of these designs produce consistent black levels, and similarly sized pixels across the dome they are designed for. Without any software warping, the images accurately reproduce the source image content with no warping degradation, overhead, or expense. Any full dome application can be used as is with no changes.

In applications where higher resolution or brightness is more desirable than projection uniformity, the source image polar projection can be defined in such a way as to use a larger portion of the available projector source frame. For example, for projection onto a truncated spherical screen, a polar projection format could be used where the radial axis scale is a function of the angular coordinate. An example is an elliptical polar projection format where a standard circular polar image is essentially scaled horizontally to fit the projector frame. The black level and pixel sizes will be non-uniform, but the displayed image will be brighter and have a higher overall resolution. Producing such a source image would just involve scaling down the height of a dome master source image of the image frame width. This scaling is simpler and less significant than the warping required with a spherical mirror system.

If a corrective lens assembly, such as an anomorphic correction lens, was placed in front of the projector, the elliptical polar projection source image could be converted into a circular polar projection format. The pixel distribution would of course still be non-uniform. This would allow a mirror designed for a circular polar image to also be used in an elliptical polar projection system.

These mirrors can be manufactured in a number of ways. Plastic thermoforming or injection molding are two possible construction methods with low unit costs. The mold or mirror could be diamond turned with suitable equipment from aluminum or similar materials for the highest quality surface. Another option is to use a CNC mill from plastic, metal, or similar materials. The process selected will depend on the quality needed for a particular application. Once the basic shape is produced, a first surface mirror coating is applied to a polished surface.

A rotationally symmetric approximation of a mirror design might be preferable in some instances due to the ease of manufacturing. This would make the most sense if distortion would be small or deemed less important.

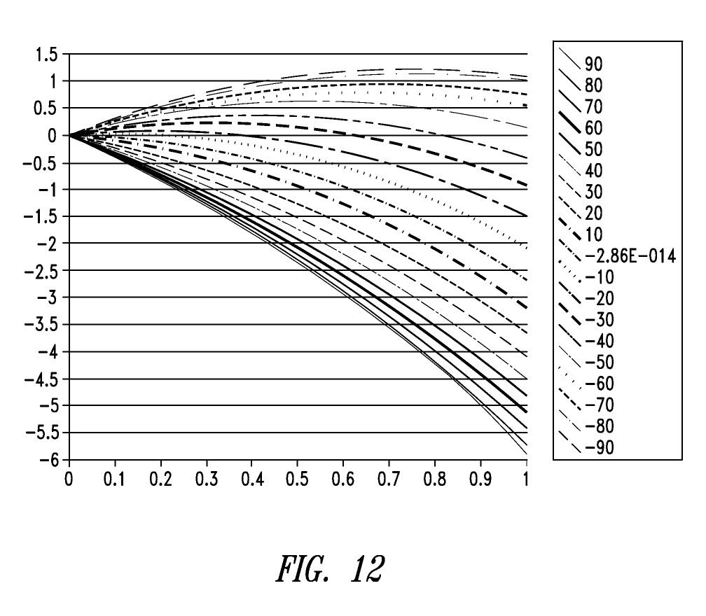

FIG. 12 is a concave design for a 16 foot diameter hemispherical dome, a mirror centered at the horizon at the edge of the dome, and minimum zoom and focus distance for a typical data projector.

The x axis is the distance away from the center of the projected image from zero at the center to 1 at the edge (horizon). The y axis is the distance of the mirror surface in inches from the center of the mirror in a horizontal direction, positive away from the center of the dome. The projector is located towards the center of the dome (negative y axis).

Each curve represents the mirror surface along a ray from the center of the projected image out to the edge for a 180 degree field of view polar projection source image. The 90 degree curve is from the center to the top of the mirror, and −90 is from the center to the bottom of the mirror. The mirror is symmetrical left to right.

The bottom of the mirror would be cut off or masked so that with a low horizon the pixels behind the mirror aren't double reflected back out onto the dome.

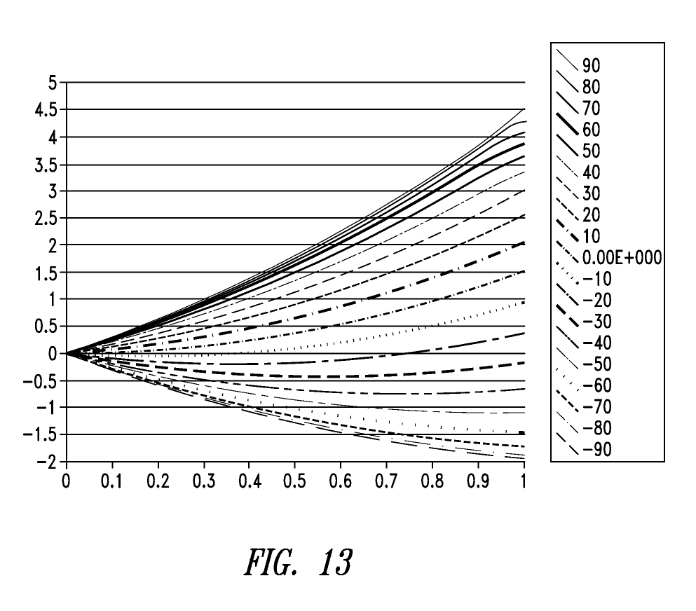

FIG. 13 is a convex design in a similar position, same projector and dome.

On the convex design, the top of the mirror has to be cut off to prevent double reflection for pixels behind the mirror. These end up just above the mirror on the dome if the source image is not masked before being projected.

All of the above U.S. patents, U.S. patent application publications, U.S. patent applications, foreign patents, foreign patent applications and non-patent publications referred to in this specification or listed in the Application Data Sheet are incorporated herein by reference in their entirety.

From the foregoing it will be appreciated that, although specific embodiments of the invention have been described herein for purposes of illustration, various modifications may be made without deviating from the spirit and scope of the invention. For example, while the present disclosure has been described in the context of domes and truncated spherical surface screens, it is to be understood that the disclosed embodiments can utilize any concave 3d surface. Moreover, the disclosed embodiments can be used with a variety of projection systems and projectors, including without limitation digital micro-mirror devices, liquid crystal, liquid crystal on silicon, direct drive image light amplifier, cathode ray tube, and laser. Accordingly, the invention is not limited except as by the appended claims that follow and the equivalents thereof.

1. An image projection system, comprising:
a projector configured to generate a projected image;
a screen having an interior surface enclosing a three-dimensional space; and
a reflector configured to receive the projected image from the projector and to reflect the projected image on the interior surface of the screen as a displayed image, the reflector comprising an aspherical reflective surface that adapts the projected image from the projector for display on the interior surface of the screen to provide complete coverage of the interior surface of the screen.

2. The system of claim 1 wherein the projected image is in a polar projection format defined to provide substantially uniform coverage of the interior surface of the screen by the displayed image.

3. The system of claim 2 where the polar projection format is a linear polar projection format and the screen is a truncated sphere in shape.

4. The system of claim 1 wherein the projected image is in a polar projection format defined to provide non-uniform coverage of the interior surface of the screen by the displayed image.

5. The system of claim 4 wherein the polar projection format is an elliptically shaped polar projection format and the screen is a truncated sphere in shape.

6. The system of claim 1 wherein the projector comprises one from among a data projector, a film projector, a slide projector, and a laser projector.

7. The system of claim 1 wherein the screen is translucent and is configured for viewing from an external side.

8. The system of claim 1 wherein the screen is opaque and is configured for viewing from an internal side.

9. The system of claim 1 wherein the reflecting surface has a concave configuration.

10. (canceled)

11. The system of claim 1 wherein the reflecting surface has a convex configuration.

12. The system of claim 1 wherein the reflecting surface has a saddle configuration.

13. The system of claim 1, further comprising one or more mirrors configured to reflect the projected image from the projector on to the reflector.

14. The system of claim 1, further comprising a converter lens assembly configured to receive the projected image from the projector and to reduce the projected image prior to reception by the reflector.

15. The system of claim 1 wherein the projector comprises a plurality of image projection devices and the reflector comprises a plurality of aspherical reflective devices, each projection device and reflective device configured to produce a substantially equal portion of the projected image for display on the screen to obtain enhanced image brightness and/or resolution.

16. The system of claim 1 wherein a means for tilting and shifting the system is provided to allow some ability to reduce distortion when used with a different sized screen than the system was designed for.

17. The system of claim 1 wherein software distortion correction is used to eliminate or reduce distortion to accommodate use with different sized screens.

18. An image capture system, comprising:
a camera configured to capture still or moving images;
a screen having an interior surface that is a truncated sphere in shape; and
a reflector configured to reflect the entire screen area for capture by the camera in a polar projection format.

19. The system of claim 1, further comprising an anomorphic type corrective lens assembly configured to receive an elliptical polar projection type projected image from the projector and to convert this to a circular polar projection type projected image prior to reception by the reflector.
